(19) United States
(12) Patent Application Publication
(10) Pub. No.: US 2014/0372988 A1
(43) Pub. Date: Dec. 18, 2014

(54) Using a Static Analysis for Configuring a Follow-On Dynamic Analysis for the Evaluation of Program Code

(71) Applicant: Microsoft Corporation, Redmond, WA (US)

(72) Inventors: Michael C. Fanning, Redmond, WA (US); Frederico A. Mameri, Seattle, WA (US); Zachary A. Nation, Seattle, WA (US); Christopher Michael Henry Faucon, Redmond, WA (US); Alexander Robin Gordon Lucas, Gloucestershire (GB)

(21) Appl. No.: 13/917,984

(22) Filed: Jun. 14, 2013

(51) Int. Cl. G06F 11/36

(52) U.S. Cl. CPC G06F 11/3612
USPC 717/131

(57) ABSTRACT

The use of a static analysis for configuring a follow-on dynamic analysis for the evaluation of program code is provided. A request may be received for configuring a static analysis session for the evaluation of the program code. The static analysis may be executed and an output may be produced therefrom. The output may be analyzed to determine whether a dynamic analysis is needed for resolving code ambiguities in the program code. If it determined that the dynamic analysis is needed, then the dynamic analysis of the program code is initiated.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Program code developers utilize static analysis annotations or models for explicitly representing information that may be difficult to compute or which documents a desirable invariant in an implementation (such as whether a parameter to a function may or may not be NULL). Static analysis models are also utilized to provide information focused on verifying a limited set of conditions around parameters provided at call sites to annotated code. Producing and maintaining static analysis models however, tends to be costly for program code developers due to the difficulties in broadening the scope/complexity of information that may be provided as developer-maintained code annotations. Drawbacks associated with static analysis models include: (1) an increase in annotation syntax complexity leads to a rapid decrease in developer enthusiasm for maintaining/authoring them; (2) it is difficult for developers to know how to express and/or where to apply annotations which describe runtime conditions/desirable invariants which aren't restricted to an obvious place in code (e.g., annotations related to concurrency and object lifetime management); and (3) many languages/associated toolsets impose practical limits on whether annotations can be applied in source code (e.g., C++ annotations and JavaScript). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for the use of a static analysis for configuring a follow-on dynamic analysis for the evaluation of program code. A request may be received for configuring a static analysis session for the evaluation of the program code. The static analysis may be executed and an output may be produced therefrom. The output may be analyzed to determine whether a dynamic analysis is needed for resolving code ambiguities in the program code. If it determined that the dynamic analysis is needed, then the dynamic analysis of the program code is initiated.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a computer architecture for using a static analysis for configuring a follow-on dynamic analysis for the evaluation of program code, in accordance with an embodiment;

FIG. 2 is a block diagram illustrating a set of components utilized by the application of FIG. 1 in using a static analysis for configuring a follow-on dynamic analysis for the evaluation of program code, in accordance with an embodiment;

FIG. 3 is a flow diagram illustrating a routine for using a static analysis for configuring a follow-on dynamic analysis for the evaluation of program code, in accordance with an embodiment; and

FIG. 4 is a simplified block diagram of a computing device with which various embodiments may be practiced;

FIG. 5A is a simplified block diagram of a mobile computing device with which various embodiments may be practiced;

FIG. 5B is a simplified block diagram of a mobile computing device with which various embodiments may be practiced; and

FIG. 6 is a simplified block diagram of a distributed computing system in which various embodiments may be practiced.

### DETAILED DESCRIPTION

Embodiments are provided for the use of a static analysis for configuring a follow-on dynamic analysis for the evaluation of program code. A request may be received for configuring a static analysis session for the evaluation of the program code. The static analysis may be executed and an output may be produced therefrom. The output may be analyzed to determine whether a dynamic analysis is needed for resolving code ambiguities in the program code. If it determined that the dynamic analysis is needed, then the dynamic analysis of the program code is initiated.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

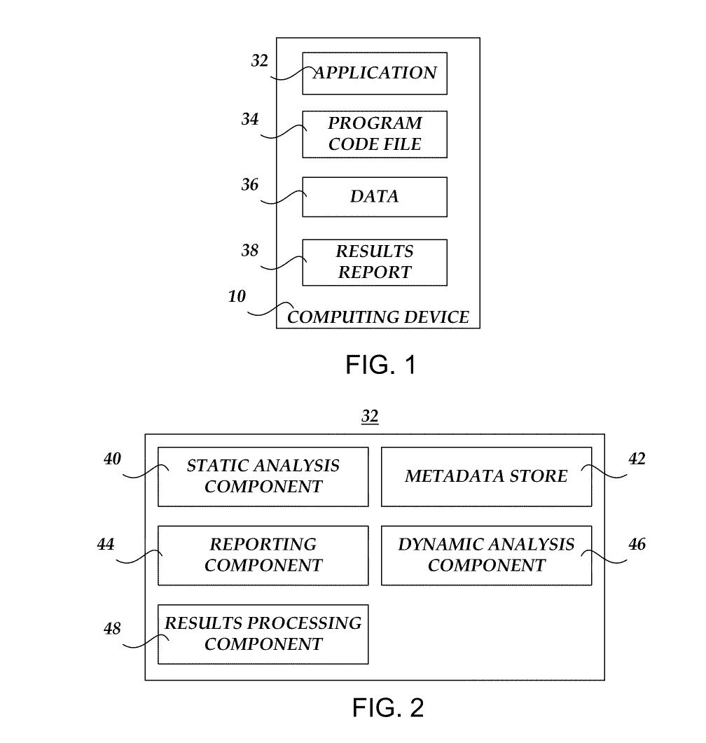

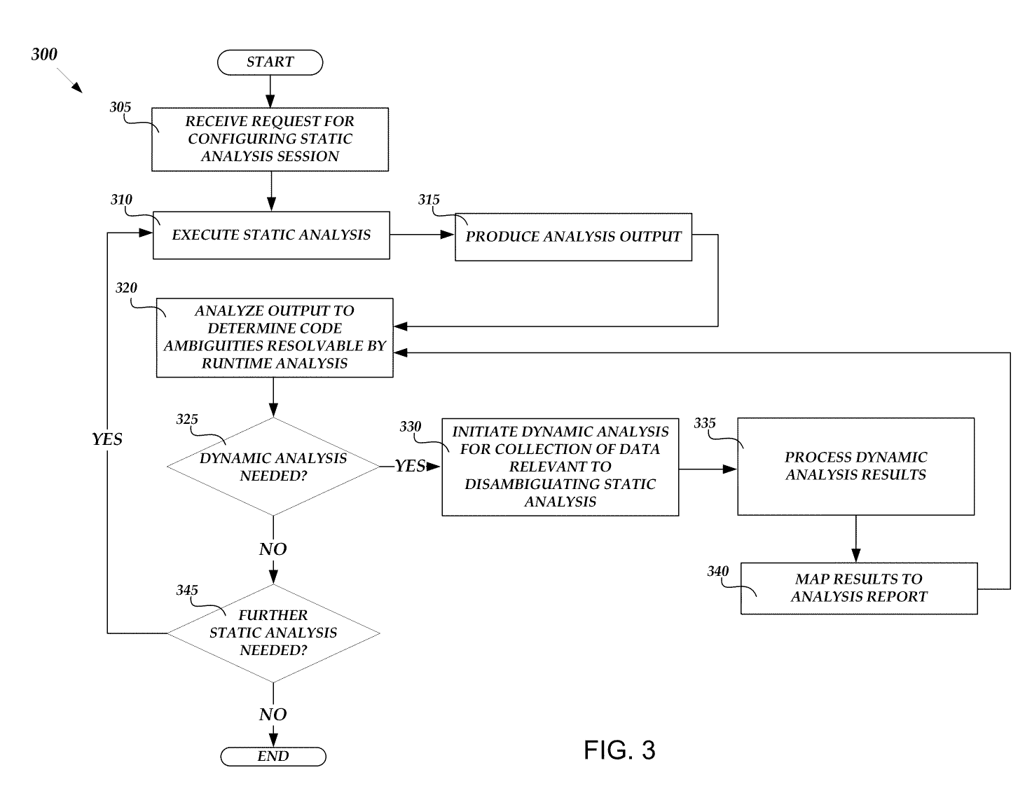

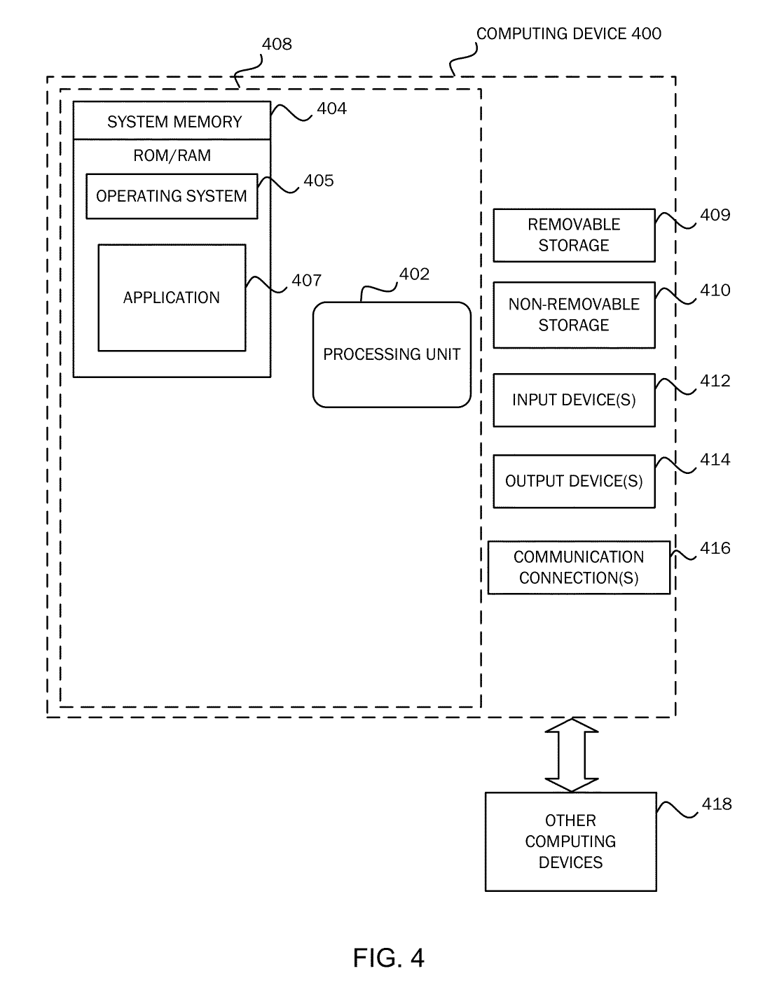

Referring now to the drawings, in which like numerals represent like elements through the several figures, various aspects of the present invention will be described. FIG. 1 is a block diagram illustrating a computer architecture for using a static analysis for configuring a follow-on dynamic analysis for the evaluation of program code, in accordance with an embodiment. The computer architecture includes a computing device 10 which may store an application 32, a program code file 34, data 36 and one or more results reports 38. As will be described in greater detail below with respect to FIGS. 2-3, the application 32 may be configured to analyze program code in the program code file 34, store/request metadata associated with programs, code locations and code constructs, receive analysis results and data 36 that documents ambiguities in a static analysis, collect data, perform profiling and other instrumentation tasks, analyze report information in order to produce a directed analysis, receive data that resolves ambiguities and generate one or more analysis reports (i.e., the results reports 38). In accordance with an embodiment, the application 32 may comprise a code analysis tool in an integrated development environment such as the VISUAL STUDIO integrated development environment (“IDE”) from MICROSOFT CORPORATION of Redmond, Wash. It should be appreciated however, that other software for analyzing code from other manufacturers may also be utilized in accordance with the various embodiments described herein. The program code in the program code file 34 may comprise JavaScript code although other code languages (e.g., C++) may also be utilized without departing from the spirit and scope of the embodiments described herein.

FIG. 2 is a block diagram illustrating a set of components utilized by the application 32 of FIG. 1 in using a static analysis for configuring a follow-on dynamic analysis for the evaluation of program code, in accordance with an embodiment. The components of the application 32 may include a static analysis component 40, a metadata store 42, a reporting component 44, a dynamic analysis component 46 and a results processing component 48. The static analysis component 40 may comprise a configurable component that is capable of receiving a request to analyze a program. The metadata store 42 may provide a facility for storing and requesting metadata associated with programs, code locations and code constructs. The reporting component 44 may be utilized to receive analysis results as well as additional data that documents ambiguities in analysis. The dynamic analysis component 46 may comprise a configurable component that is capable of a range of data collection, profiling and other instrumentation tasks. The results processing component 48 may be capable of analyzing report information in order to both produce a directed analysis (intended to resolve ambiguities encountered during a previous analysis or to provide an additional analysis after one or more ambiguities have been resolved) as well as to receive data that resolves those ambiguities.

FIG. 3 is a flow diagram illustrating a routine 300 for using a static analysis for configuring a follow-on dynamic analysis for the evaluation of program code, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in hardware, in firmware, in special purpose digital logic, and any combination thereof without deviating from the spirit and scope of the present invention as recited within the claims set forth herein.

The routine 300 begins at operation 305, where the application 32 executing on the computing device 10, may receive a request for configuring a static analysis session. In particular, the static analysis component 40 may be utilized to receive a request to analyze program code in the program code file 34 from a user/developer.

From operation 305, the routine 300 continues to operation 310, where the application 32 executing on the computing device 10, may execute a static analysis of the program code in the program code file 34. It should be understood that static program analysis may include the analysis of computer software that is performed without actually executing programs (analysis performed on executing programs is known as dynamic analysis. Static program analysis may be performed on source code or object code. Static program analysis may consider various behaviors including individual statements and declarations as well as the complete source code of a program. The use of the information obtained from the analysis may include highlighting possible coding errors and proving properties about a given program (e.g., the program's behavior matches that of its specification).

From operation 310, the routine 300 continues to operation 315, where the application 32 executing on the computing device 10, may produce an output of the static analysis performed at operation 310.

From operation 315, the routine 300 continues to operation 320, where the application 32 executing on the computing device 10, may analyze the output produced at operation 315 to determine code ambiguities that may be resolvable by runtime analysis. In particular, the application 32 may determine whether the aforementioned code ambiguities may be eliminated by performing a dynamic analysis of the program code in the program code file 34. The code ambiguities may include one or more errors or missing data that substantively prevents further analysis such as, for example, one or more variable types which could not be determined for a particular function, the use of prohibited functions (for which additional information may be useful to analyze the code, such as the data which is provided to the prohibited functions as parameters), etc.

From operation 320, the routine 300 continues to operation 325, where the application 32 executing on the computing device 10, may determine whether to perform a dynamic analysis for the code ambiguities determined at operation 320. It should be understood that dynamic program analysis may include the analysis of computer software that is performed by executing programs on a real or virtual processor. It should be further understood that a follow-on dynamic analysis may be requested and performed by the application 32 when the analysis of the output performed at operation 320 indicates the existence of code ambiguities that may be resolvable by a runtime analysis (e.g., one or more variable types could not be determined for a particular function) and after an examination of in-source code comments, side-car files, or other persisted data stores to resolve the code ambiguities during the static analysis has failed. If, at operation 325, it is determined that a dynamic analysis is needed, then the operation 325 continues to operation 330. If however, at operation 325, it is determined that a dynamic analysis is not needed, then the routine 300 branches to operation 345.

At operation 330, the application 32 executing on the computing device 10, may initiate a dynamic analysis for the collection of data relevant to disambiguating (i.e., eliminating) the code ambiguities determined from the analysis of the output at operation 320. In accordance with an embodiment, the collected data may include, for example program binaries, enumerated data values associated with an object instance (where the object instance is associated with a code location in the program code, a call stack for execution of a code location, and path and parameter/variable value information collected in one or more functions for program code and data coverage.

From operation 330, the routine 300 continues to operation 335, where the application 32 executing on the computing device 10, may process the results of the dynamic analysis initiated at operation 330.

From operation 335, the routine 300 continues to operation 340, where the application 32 executing on the computing device 10, may map the results of the dynamic analysis to an analysis report (i.e., the results report 38). In particular, the results of the dynamic analysis may be merged/rationalized with the original static analysis results.

From operation 340, the routine 300 returns to operation 320 for the determination of additional code ambiguities, which may be present in the program code file 34, which are resolvable by runtime analysis.

At operation 345, after the application 32 has determined that a dynamic analysis does not need to be performed for the code ambiguities determined at operation 320, a determination is then made as to whether further static analysis is needed. In particular, a subsequent static analysis may be needed if one or more code ambiguities in the program code have been resolved by performing a dynamic analysis. A further static analysis may be configured on the basis of processing arbitrary additional information collected during one or more dynamic analyses. In some cases, further static analysis may be useful if one or more dynamic analyses have occurred, even if no analysis output has been modified or additional data has been produced by the dynamic analysis. If, at operation 345, the application 32 determines that a further or subsequent static analysis is needed, then the routine 300 returns to operation 310 where the subsequent static analysis is executed. If, however, at operation 345, the application 32 determines that a subsequent analysis is not needed (i.e., there are no remaining code ambiguities which need to be resolved), then the routine 300 then ends.

It should be understood that the operations in the routine 300 described above may be performed on various types of program code. For example, following below is an example of a JavaScript program code (with no additional information) authored in a program file:

```
testFile.js :
function test(varOne, varTwo, varThree, varFour) {
  if (varOne) {
    varTwo.doSomethng( );
  }
  else {
    eval(varThree);
  }
  varFour(“doSomethingElse( )”);
}
```

The performance of a static analysis of the above code may produce the following report:
RESULT, test.js(1,1-188), ERROR, JS2085. Code should run in strict mode wherever possible.
RESULT, test.js(2,4-98), ERROR, JS2016, Place ‘else’ keyword on the same line as the closing brace of the previous control block.
RESULT, test.js(6,8-22), ERROR, JS2001: Do not use the ‘eval’ function.
TYPES, testFilejs::test(1,1-188), UNKNOWN

Based on the above report, the application 32 may determine that one or more types could not be determined for a function test in in the file named “testFile:js” and subsequently request a follow-on dynamic analysis to disambiguate variable types for the aforementioned function. It should be understood that the request may further specify one or more individual variable types, be made to disambiguate a specific call site in a routine, etc. It should be understood that after having emitted a problem report and configuration information for a follow-on dynamic analysis, the well-known results may (or may not) be displayed to a user. In accordance with an embodiment, the application 32 may be configured to automatically initiate a directed run of the program code (e.g., it may be configured to run a configured set of tests or may be driven through some other automated code execution) or the dynamic analysis report may simply be accessed the next time the user chooses to run the application (e.g., in context of debugging it). In accordance with an embodiment, the application 32 may be configured to provide a user interface (“UI”) which the user may consult and which may be configured to show the places in code that are currently in an ambiguous state as well as the analysis results that are actionable. In accordance with an embodiment, the UI may comprise an error list and code regions that are ambiguous may be highlighted in a code editor. It should further be understood that the application 32 may utilize the results processing component 48 to examine the information described above and extract any data from it that is useful for or needed to configure a subsequent dynamic analysis. In accordance with the currently described example, the results processing component 48 may take advantage of the flexibility of JavaScript and simply rewrite the code example to collect required data as follows:

```
function test(varOne, varTwo, varThree, varFour) {
  CollectTypeInformation(varOne, varTwo, varThree, varFour);
  if (varOne) {
    varTwo.doSomethng( );
  }
  else {
    hookedEval(varThree);
    }
    varFour(‘doSomethingElse( )’);
}
```

As may be seen from the code above, a call has been injected to the beginning of function ‘test’ which will pass all function parameters to a helper that will determine the type/enumerate members/etc. for the provided variables. This helper may reside in a distinct source file that has been force-loaded at runtime. The helper may call into external components that provide increased object enumeration capabilities or other functionality. The call to ‘eval’ above has also been rewritten to call into a helper provided by the system ‘hookedEval’. The helper inspects the argument provided to eval and then subsequently calls the actual eval implementation. During partial execution of the above code at runtime, the following observations may be made by the application 32: varOne is determined to be a Boolean type with a value that is consistently set to ‘false’ (with the result that the conditional associated with the call through varTwo is never executed), varTwo is determined to be an instance of a type named CustomType, varThree is observed to always consist of a string value that appears to represent JSON data and varFour is observed to be a function reference to the built-in eval function. After the above runtime observations have been made, the runtime collect information may be merged into a results report which may read as follows:
RESULT, test.js(1,1-188), ERROR, JS2085. Code should run in strict mode wherever possible.
RESULT, test.js(2,4-98), ERROR, JS2016, Place ‘else’ keyword on the same line as the closing brace of the previous control block.
RESULT, test.js(6,8-22), ERROR, JS2001: Do not use the ‘eval’ function. This use of ‘eval’ appears to be replaceable by JSON.parse;
TYPES, testFilejs::test(1,1-188), RESOLVED
RESULT, test.js(8, 4011), ERROR, Do not create or call through aliases to ‘eval’

It should be understood that the original results have been updated in several ways. For example, a result produced by the original static analysis report (of JS2001) has been improved upon. In particular, where the use of eval was previously flagged, the user is now notified that the specific usage of eval may be replaceable by JSON.parse (based on the observation that the associated call site is passed JSON data). Furthermore, the TYPES entry that previously specified one or more unknown types for function test in testFiles.js has been marked as RESOLVED. Furthermore, the dynamic analysis has itself produced a useful result to be reported to users. In particular, varFour was observed to be an alias to the eval function (the use of which is generally prohibited in the example being presently described).

In accordance with an embodiment, supporting type information collected at runtime (or any other metadata that's collected) may be written to a separate store, in-lined into source code, etc. The request may be marked to collect the supporting type information, as resolved in the results report, in order to assist configuration of a follow-on static analysis. For example, if the dynamic analysis is configured to rewrite the user source code with annotations to help track type information, in-lined comment-based annotations may be utilized follow the convention shown below. It should be understood that the static analysis component 40 may be capable of reading the in-lined annotations as well as others that exist in separate files/persisted stores. For example, models for the type named ‘CustomType’ may be emitted to a separate location that is accessible to a static checker. The model for ‘CustomType’ may indicate that it is defined as a class that consists of a single member (i.e., a function named ‘doSomething( )’ that accepts no parameters).

```
function test(/* @type(Boolean) */ varOne, /* @type(CustomType)
*/ varTwo, /* @type(String) */ varThree, /* @type(Function)
*/ varFour) {
    if (varOne) {
        varTwo.doSomethng( );
    }
    else {
        eval(varThree);
    }
}
```

It should be understood that after having rewritten the results report, a portion of the user code, and having updated the persisted models consumed by static checkers, the results processing component 48 may now be utilized to examine a current report. The conversion of the ‘TYPES’ entry for function ‘test’ from UNKNOWN to RESOLVED (see above), for example, indicates that a follow-on static analysis may produce additional results. Thus, the ‘TYPES’ entry may be removed entirely from the report and a new static analysis may be configured. As there is no indication elsewhere in the report that additional state/data has been collected that is relevant to the previous analysis, the new static analysis may be configured to restrict its operation only to a local construct (i.e., the function named ‘test’ in the program file testFile.js) for which new metadata has been produced.

It should be understood that as part of configuring a new static analysis run (which may be completely recreated or incremental), the results entry re: updated type information may be removed. Upon the occurrence of the follow-on static analysis, the models for all variables associated with the function ‘test’ may be available. The result of the follow-on static analysis may produce a useful new analysis result, namely an error that a member named ‘doSomethng’ cannot be located for varTwo (which is known to be of type ‘CustomType’ as of the most recent dynamic analysis). Thus, the use of the ‘doSomethng’ member may be determined to be a typo (i.e., the correct spelling being ‘doSomething’) and a problem may be written to the report as shown in the final report, below:
RESULT, test.js(1,1-188), ERROR, JS2085. Code should run in strict mode wherever possible.
RESULT, test.js(2,4-98), ERROR, JS2016, Place ‘else’ keyword on the same line as the closing brace of the previous control block.
RESULT, test.js(6,8-22), ERROR, JS2001: Do not use the ‘eval’ function. This use of ‘eval’ appears to be replaceable by JSON.parse;
RESULT, test.js(8, 10-11), ERROR, Do not create or call through aliases to ‘eval’
RESULT, test.js(3, 17-17), ERROR, JS3092: ‘CustomType.prototype’ does not contain a definition for ‘doSomethng’.
   As may be seen from the above final report, all of the notations with respect to the code ambiguities discussed above have been eliminated and the follow-on static analysis (working in concert with models acquired dynamically) has produced an error regarding the misspelled member reference on the ‘varTwo’ variable.

It should be appreciated that in accordance with the embodiments described herein, a preliminary static analysis may be utilized to create a directed instrumentation plan for a dynamic analysis, which limits the performance impact/intrusiveness of the analysis. Furthermore, the low impact of the information collection process may encourage users to enable it in ad hoc debugging/general use. It should further be appreciated that the dynamic analysis may produce a high certainty of information which may be difficult to compute otherwise. For example, producing type/member information for dynamic language objects is a difficult problem which occurs in dynamic programming languages. It should further be understood that the dynamic analysis described herein does not literally prompt code execution for all code paths. However, static analysis may be utilized to inspect any uncovered code and, with the high-value metadata collected during the dynamic analysis, produce a useful observation that the uncovered code path will raise a runtime exception (e.g., because the developer has incorrectly specified a member name in the uncovered code path). The following is a non-exhaustive list of runtime data that may be configured for collection during dynamic analysis:

Capture and report all binaries that are loaded into memory;

Enable a specific runtime check;

Report the observed type at runtime for one or more variables/parameters/etc.;

Enumerate all functions/members for an instance of a specific type (potentially at a specific code location);

Enumerate all data values associated with an object instance associated w/a specific code location;

Report the observed values/range of values for one or more variables/parameters/etc.; Produce a call stack for every execution of a specific code location;

Report the specific concrete type associated with a variable of an abstract type at a specific location;

Report the specific bound function/member at a virtual call site when executed at runtime;

Instrument one or more functions for path and data code coverage;

Report the thread id/other runtime state that exists on hitting a specific code location;

Report the number of instances of a specific type that are allocated during execution;

Report the number of times a specific code location is hit;

Log the specific path through specific function (possibly coupled with tracking variable values during execution); and

Enable logging for specific operating system operations (e.g., file I/O, registry access, network/http requests, etc.).

It should further be understood that techniques in the above described embodiments may be combined into a common report that documents the results achieved thus far, as well as any remaining ambiguities in code that, if resolved, might produce additional analysis. As a result, a clear and current status of the program code may be broadcast to users and prompt users to proactively resolve remaining ambiguities.

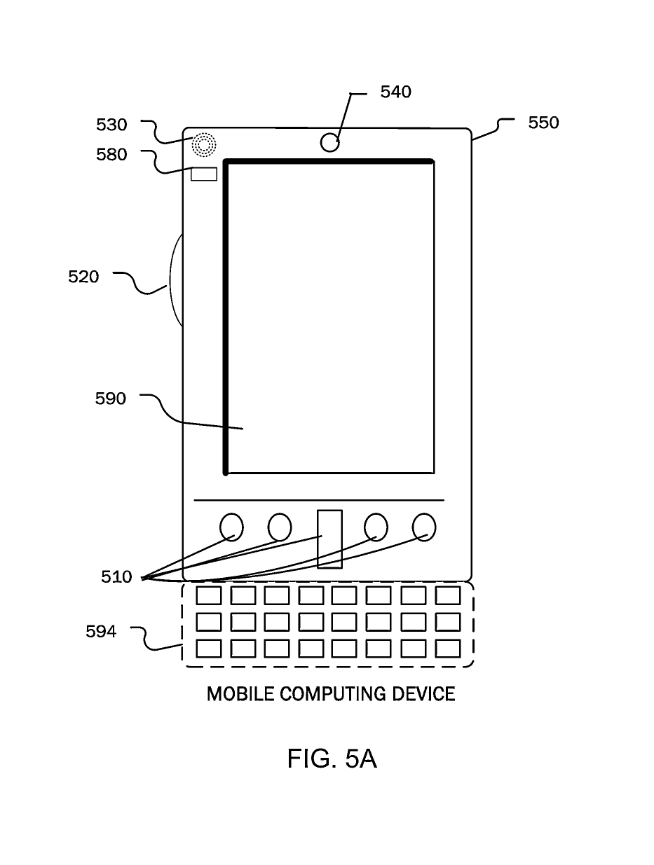

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating example physical components of a computing device 400 with which various embodiments may be practiced. In a basic configuration, the computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include an operating system 40l and application 407. Operating system 405, for example, may be suitable for controlling the computing device 400's operation and, in accordance with an embodiment, may comprise the WINDOWS operating systems from MICROSOFT CORPORATION of Redmond, Wash. The application 407, for example, may comprise functionality for performing routines including, for example, using a static analysis for configuring a follow-on dynamic analysis for the evaluation of program code, as described above with respect to the operations in routine 300 of FIG. 3. It should be understood, however, that the embodiments described herein may also be practiced in conjunction with other operating systems and application programs and further, is not limited to any particular application or system.

The computing device 400 may have additional features or functionality. For example, the computing device 400 may also include additional data storage devices (removable and/or non-removable) such as, for example, magnetic disks, optical disks, solid state storage devices (“SSD”), flash memory or tape. Such additional storage is illustrated in FIG. 4 by a removable storage 409 and a non-removable storage 410. The computing device 400 may also have input device(s) 412 such as a keyboard, a mouse, a pen, a sound input device (e.g., a microphone), a touch input device for receiving gestures, an accelerometer or rotational sensor, etc. Output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 400 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

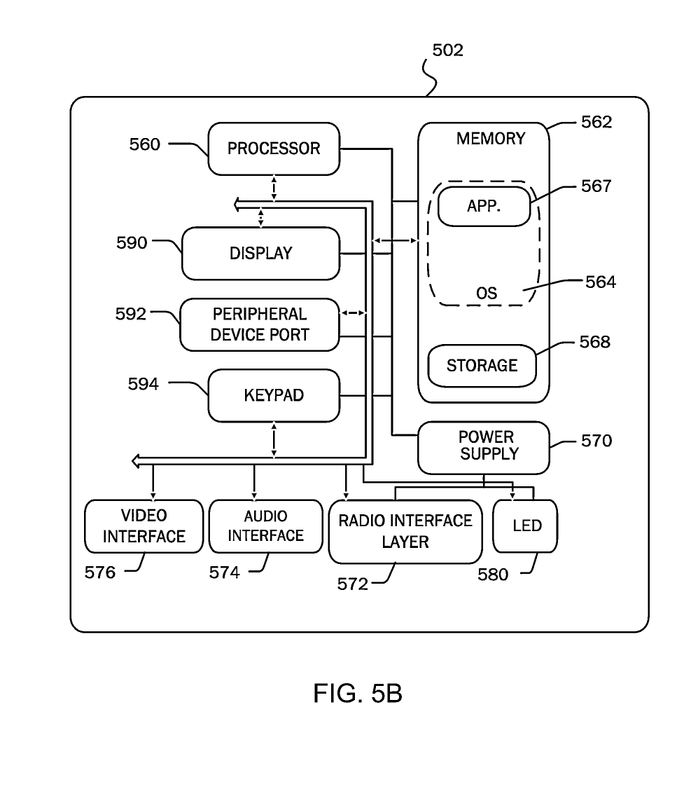

FIGS. 5A and 5B illustrate a suitable mobile computing environment, for example, a mobile computing device 550 which may include, without limitation, a smartphone, a tablet personal computer, a laptop computer, and the like, with which various embodiments may be practiced. With reference to FIG. 5A, an example mobile computing device 550 for implementing the embodiments is illustrated. In a basic configuration, mobile computing device 550 is a handheld computer having both input elements and output elements. Input elements may include touch screen display 525 and input buttons 510 that allow the user to enter information into mobile computing device 550. Mobile computing device 550 may also incorporate an optional side input element 520 allowing further user input. Optional side input element 520 may be a rotary switch, a button, or any other type of manual input element. In alternative embodiments, mobile computing device 550 may incorporate more or less input elements. In yet another alternative embodiment, the mobile computing device is a portable telephone system, such as a cellular phone having display 525 and input buttons 510. Mobile computing device 550 may also include an optional keypad 505. Optional keypad 505 may be a physical keypad or a “soft” keypad generated on the touch screen display.

Mobile computing device 550 incorporates output elements, such as display 525, which can display a graphical user interface (GUI). Other output elements include speaker 530 and LED 580. Additionally, mobile computing device 550 may incorporate a vibration module (not shown), which causes mobile computing device 550 to vibrate to notify the user of an event. In yet another embodiment, mobile computing device 550 may incorporate a headphone jack (not shown) for providing another means of providing output signals.

Although described herein in combination with mobile computing device 550, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 5B is a block diagram illustrating components of a mobile computing device used in one embodiment, such as the mobile computing device 550 shown in FIG. 5A. That is, mobile computing device 550 can incorporate a system 502 to implement some embodiments. For example, system 502 can be used in implementing a “smartphone” that can run one or more applications similar to those of a desktop or notebook computer. In some embodiments, the system 502 is integrated as a computing device, such as an integrated personal digital assistant (PDA) and wireless phone.

Application 567 may be loaded into memory 562 and run on or in association with an operating system 564. The system 502 also includes non-volatile storage 568 within memory the 562. Non-volatile storage 568 may be used to store persistent information that should not be lost if system 502 is powered down. The application 567 may use and store information in the non-volatile storage 568. The application 567 may also include functionality for performing routines including, for example, using a static analysis for configuring a follow-on dynamic analysis for the evaluation of program code, as described above with respect to the operations in routine 300 of FIG. 3. A synchronization application (not shown) also resides on system 502 and is programmed to interact with a corresponding synchronization application resident on a host computer to keep the information stored in the non-volatile storage 568 synchronized with corresponding information stored at the host computer. As should be appreciated, other applications may also be loaded into the memory 562 and run on the mobile computing device 550.

The system 502 has a power supply 570, which may be implemented as one or more batteries. The power supply 570 might further include an external power source, such as an AC adapter or a powered docking cradle that supplements or recharges the batteries.

The system 502 may also include a radio 572 (i.e., radio interface layer) that performs the function of transmitting and receiving radio frequency communications. The radio 572 facilitates wireless connectivity between the system 502 and the “outside world,” via a communications carrier or service provider. Transmissions to and from the radio 572 are conducted under control of OS 564. In other words, communications received by the radio 572 may be disseminated to the application 567 via OS 564, and vice versa.

The radio 572 allows the system 502 to communicate with other computing devices, such as over a network. The radio 572 is one example of communication media. The embodiment of the system 502 is shown with two types of notification output devices: the LED 580 that can be used to provide visual notifications and an audio interface 574 that can be used with speaker 530 to provide audio notifications. These devices may be directly coupled to the power supply 570 so that when activated, they remain on for a duration dictated by the notification mechanism even though processor 560 and other components might shut down for conserving battery power. The LED 580 may be programmed to remain on indefinitely until the user takes action to indicate the powered-on status of the device. The audio interface 574 is used to provide audible signals to and receive audible signals from the user. For example, in addition to being coupled to speaker 530, the audio interface 574 may also be coupled to a microphone (not shown) to receive audible (e.g., voice) input, such as to facilitate a telephone conversation. In accordance with embodiments, the microphone may also serve as an audio sensor to facilitate control of notifications. The system 502 may further include a video interface 576 that enables an operation of on-board camera 540 to record still images, video streams, and the like.

A mobile computing device implementing the system 502 may have additional features or functionality. For example, the device may also include additional data storage devices (removable and/or non-removable) such as, magnetic disks, optical disks, or tape. Such additional storage is illustrated in FIG. 5B by storage 568.

Data/information generated or captured by the mobile computing device 550 and stored via the system 502 may be stored locally on the mobile computing device 550, as described above, or the data may be stored on any number of storage media that may be accessed by the device via the radio 572 or via a wired connection between the mobile computing device 550 and a separate computing device associated with the mobile computing device 550, for example, a server computer in a distributed computing network such as the Internet. As should be appreciated such data/information may be accessed via the mobile computing device 550 via the radio 572 or via a distributed computing network. Similarly, such data/information may be readily transferred between computing devices for storage and use according to well-known data/information transfer and storage means, including electronic mail and collaborative data/information sharing systems.

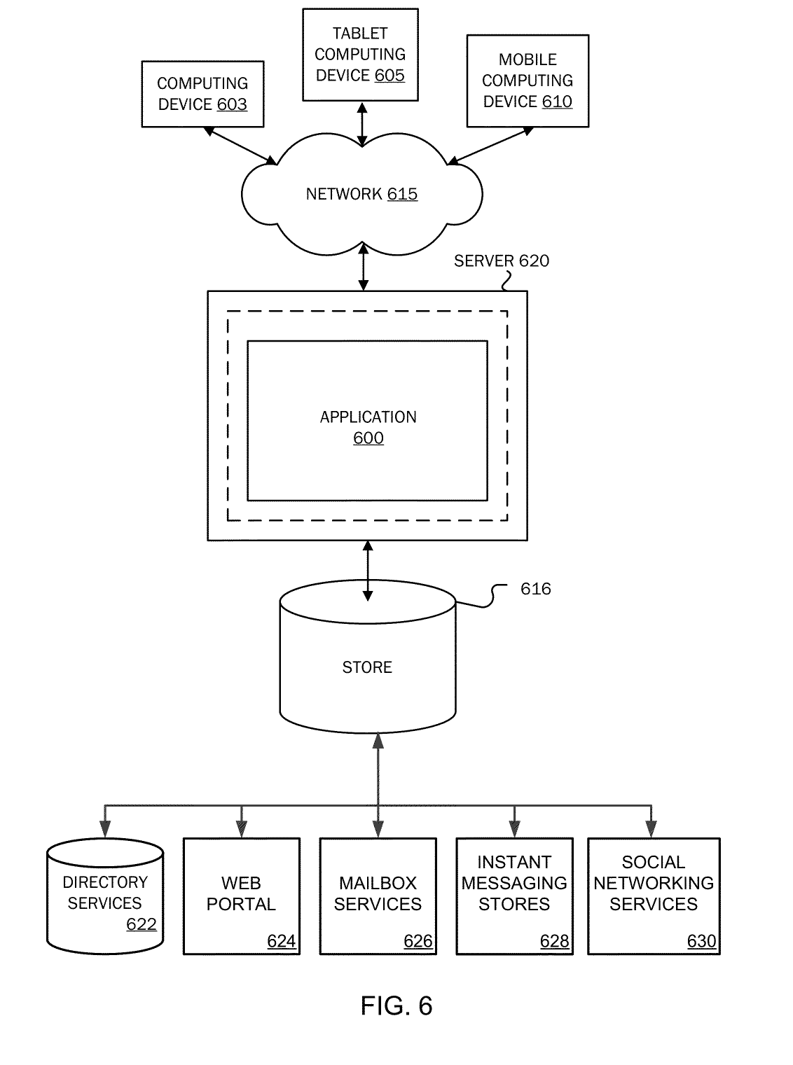

FIG. 6 is a simplified block diagram of a distributed computing system in which various embodiments may be practiced. The distributed computing system may include number of client devices such as a computing device 603, a tablet computing device 605 and a mobile computing device 610. The client devices 603, 605 and 610 may be in communication with a distributed computing network 615 (e.g., the Internet). A server 620 is in communication with the client devices 603, 605 and 610 over the network 615. The server 620 may store application 600 which may perform routines including, for example, using a static analysis for configuring a follow-on dynamic analysis for the evaluation of program code, as described above with respect to the operations in routine 300 of FIG. 3. Content developed, interacted with, or edited in association with the application 600 may be stored in different communication channels or other storage types. For example, various documents may be stored using a directory service 622, a web portal 624, a mailbox service 626, an instant messaging store 628, or a social networking site 630.

The application 600 may use any of these types of systems or the like for enabling data utilization, as described herein. The server 620 may provide the application 600 to clients. As one example, the server 620 may be a web server providing the application 600 over the web. The server 620 may provide the application 600 over the web to clients through the network 615. By way of example, the computing device 10 may be implemented as the computing device 603 and embodied in a personal computer, the tablet computing device 605 and/or the mobile computing device 610 (e.g., a smart phone). Any of these embodiments of the computing devices 603, 605 and 610 may obtain content from the store 616.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of using a static analysis for configuring a follow-on dynamic analysis for the evaluation of program code, comprising:
receiving, by a computing device, a request for configuring a static analysis session for the evaluation of the program code;
executing, by the computing device, the static analysis;
producing, by the computing device, an output from the static analysis;
analyzing, by the computing device, the output of the static analysis;
determining, by the computing device, whether to perform a dynamic analysis for resolving code ambiguities; and
upon determining, by the computing device, to perform the dynamic analysis, initiating the dynamic analysis of the program code.

2. The method of claim 1 wherein analyzing, by the computing device, the output of the static analysis comprises determining program code ambiguities resolvable by a runtime analysis.

3. The method of claim 1, wherein initiating the dynamic analysis of the program code comprises collecting data relevant to resolving the code ambiguities.

4. The method of claim 3, wherein collecting data relevant to resolving the code ambiguities comprises collecting data relevant to eliminating the code ambiguities.

5. The method of claim 3, further comprising:
processing results of the dynamic analysis; and
mapping the results of the dynamic analysis to an analysis report.

6. The method of claim 1, further comprising determining whether to perform a subsequent static analysis.

7. The method of claim 5, further comprising executing the subsequent static analysis.

8. A computing device comprising:
a memory for storing executable program code; and
a processor, functionally coupled to the memory, the processor being responsive to computer-executable instructions contained in the executable program code and operative to:
receive a request to configure a static analysis session for the evaluation of program code;
execute the static analysis;
produce an output from the static analysis;
analyze the output of the static analysis to determine code ambiguities resolvable by a runtime analysis;
determine whether to perform a dynamic analysis for resolving the code ambiguities; and
initiate the dynamic analysis of the program code.

9. The computing device of claim 8, wherein the processor, in initiating the dynamic analysis of the program code, is operative to collect data relevant to eliminating the code ambiguities.

10. The computing device of claim 9, wherein the processor is further operative to:
process results of the dynamic analysis; and
map the results of the dynamic analysis to an analysis report.

11. The computing device of claim 8, wherein the processor is further operative to determine whether to perform a subsequent static analysis.

12. The computing device of claim 11, wherein the processor is further operative to execute the subsequent static analysis.

13. The computing device of claim 9, wherein the data relevant to eliminating the code ambiguities comprises program binaries that are loaded into the memory.

14. The computing device of claim 9, wherein the data relevant to eliminating the code ambiguities comprises at least one of enumerated data values and type information associated with an object.

15. The computing device of claim 9, wherein the data relevant to eliminating the code ambiguities comprises a call stack for execution of a code location.

16. The computing device of claim 9, wherein the data relevant to eliminating the code ambiguities comprises path and variable data collected for one or more functions.

17. A computer-readable storage medium storing computer executable instructions which, when executed on a computing device, will cause the computing device to perform a method of configuring a follow-on dynamic analysis for the evaluation of program code, the comprising:
receiving a request for configuring a static analysis session for the evaluation of the program code;
executing the static analysis;
producing an output from the static analysis;
analyzing the output of the static analysis to determine program code ambiguities resolvable by a runtime analysis;
determining whether to perform a dynamic analysis for resolving code ambiguities;
upon determining to perform the dynamic analysis, initiating the dynamic analysis of the program code to collect data relevant for resolving the code ambiguities;
processing results of the dynamic analysis; and
mapping the results of the dynamic analysis to an analysis report.

18. The computer-readable storage medium of claim 17, wherein collecting data relevant for resolving the code ambiguities comprises collecting data relevant to eliminating the code ambiguities.

19. The computer-readable storage medium of claim 17, further comprising determining whether to perform a subsequent static analysis.

20. The computer-readable storage medium of claim 19, further comprising executing the subsequent static analysis.
